(19) United States
(12) Patent Application Publication
(10) Pub. No.: US 2022/0410261 A1
(43) Pub. Date: Dec. 29, 2022

(54) A METHOD OF MANUFACTURING A COMPOSITE COMPONENT WITH VARYING ELECTRIC RESISTIVITY ALONG A LONGITUDINAL DIRECTION

(71) Applicant: Grundfos Holding A/S, Bjerringbro (DK)

(72) Inventors: Flemming Buus Bendixen, Hobro (DK); Peter Valler, Aalborg SØ (DK); Alexandro Sorea, Aalborg Ø (DK); Henrik Rasmussen, Rødkærsbro (DK)

(21) Appl. No.: 17/781,640

(22) PCT Filed: Dec. 3, 2020
(86) PCT No.: PCT/EP2020/084447

§ 371 Date: Jun. 1, 2022

(30) Foreign Application Priority Data
Dec. 4, 2019 (EP) 19213519.2
Dec. 4, 2019 (EP) 19213523.4

(51) Int. Cl. B22F 3/20; B28B 3/20; B22F 3/22; B22F 7/06

(52) U.S. Cl. CPC B22F 3/20; B28B 3/20; B22F 3/227; B22F 7/06; B28B 2003/203; B22F 2999/00

(57) ABSTRACT

The invention relates to a method of manufacturing a composite component (21) having a varying electric resistivity along a longitudinal direction of the component. At least a first paste (10a) having a first composition, and at least a second paste (10b) having a second composition are prepared. The pastes are transferred into a supply chamber (35) of a processing equipment (31), such as an extruder. A green body (20) is shaped by forcing the pastes from the supply chamber through a die (32), and the green body is then sintered or oxidized to form the composite component. The pastes may comprise metal powder, ceramic powder, and binder. The varying electric resistivity may be due to variations in one or more of the following parameters: the volume ratio between the metal powder and the ceramic powder, the size of the ceramic particles, and the type of the ceramic material.

### FIELD OF THE INVENTION

The present invention relates to a method of manufacturing a composite component, and in particular to such a method involving sintering or oxidizing of powder-based material and resulting in a composite component having a varying electric resistivity along a longitudinal direction of the component.

### BACKGROUND OF THE INVENTION

Within many technical fields, it is well-known to utilize the electrical properties of a metal component to conduct electrical power. It may e.g. be in order to transfer the electrical power from a power source to another unit that is driven by the power, such as in electrical cables. It may also be in order to use the electrical power to heat the electrically conducting component due to the electric resistivity of the metal and then use the heated metal for the heating of another media, such as a fluid flowing along the metal. However, since electrical power follows the shortest conducting path through the metal component, this may give rise to some regions thereof becoming too hot while others are at significantly lower temperatures. This can both cause damage to the component and also result in an insufficient utilization of the amount of material available in the component.

Hence, an improved method of manufacturing a composite component would be advantageous. In particular it would be relevant in relation to such composite components to be made from metal-based material and which are to be used for the transfer of electrical power.

### OBJECT OF THE INVENTION

Thus, it is an object of the present invention to provide a method of manufacturing a composite component with which the electrical properties of the component can be adapted to a given application of the component.

It is another object of the present invention to provide a method of manufacturing a composite component with which it is possible to obtain a composite component having non-constant electrical properties along a longitudinal direction.

It is an object of some embodiments of the invention to provide a method of manufacturing a metal composite component comprising sintering or oxidizing of powder-based material.

It is a further object of the present invention to provide an alternative to the prior art.

In particular, it may be seen as an object of the present invention to provide a method of manufacturing a composite component that solves the above mentioned problems of the prior art.

### SUMMARY OF THE INVENTION

Thus, the above described object and several other objects are intended to be obtained in a first aspect of the invention by providing a method of manufacturing a composite component having a varying electric resistivity along a longitudinal direction, the method comprising the following steps:
preparing a plurality of pastes comprising:
   at least a first paste having a first composition, and
   at least a second paste having a second composition,
transferring the plurality of pastes into a supply chamber of a processing equipment,
shaping a green body from the plurality of pastes by forcing the pastes from the supply chamber through a die of the processing equipment, and
sintering or oxidizing the green body to obtain the composite component having the varying electric resistivity along the longitudinal direction of the composite component, the longitudinal direction corresponding to the direction of movement of the pastes through the die, and the varying electric resistivity resulting from the first composition being different from the second composition.

By “composite” is in general meant being made up of distinct parts or elements. In relation to the present invention, it refers to the composite component being manufactured from a plurality of pastes of different compositions. For some of the embodiments, each of the pastes may in itself constitute a composite material, such as by comprising both metal and ceramic material as will be described in the following.

The varying electric resistivity may be referred to as being predetermined in the sense that it has been determined as part of the design process in accordance with the desired non-constant electrical properties needed for a given application of the component. Or in other words, the electric resistivity is the parameter being decisive for the choice of the compositions of the first and second pastes.

The step of preparing the pastes may be performed by kneading the materials in a kneader, such as a Z-blade kneader or sigma blade kneader.

By “paste” is meant a thick, soft, sticky substance made by mixing a liquid with a powder. In other words, pastes typically consist of a suspension of granular material in a background fluid. In the context of the present invention, the viscosity of the paste should be so that it allows for the necessary handling of the paste during the transfer from the device used for the preparation of the paste and to the processing equipment. It should also allow for the subsequent process steps; i.e. it should be low enough to allow for the shaping via the die and high enough to ensure that the shaped green body keeps the desired geometry. The viscosity of a given paste can be determined by equipment and methods designed therefore, such as by use of a capillary rheometer which is typically used to measure shear viscosity and other rheological properties. However, since the viscosity is correlated to the hardness of the material, it will also be possible to use this parameter in the determination of whether a given paste is suitable for the manufacturing method or not. A possible related measure to use is the Shore Hardness which can be determined in accordance with ISO 868/ASTM D2240. Another option is to use a special tool designed for clays; this has been used during the development of the present invention. This tool is similar to a Shore tester but has been adapted for the characterization of clays; such an instrument can also be referred to as a durometer for clays. The operating principle is based on the force exerted by the sample material on the penetration of the calibrated spring of the instrument, when a pin of the tool is pressed into the material being tested until the pin reaches a support. In this way, a steady force at a steady stroke is always applied to the instrument. It has a scale from 0 to 20 to use as a relative hardness reference parameter, and gram scale of applied force. With this tool, a penetration point is pressed into the paste when it comes out of the kneader. Then the maximum value indicated at the moment when the penetration point is inside the paste is measured. The maximum point is used instead of waiting for it to stabilize because it will eventually show a much lower value, maybe getting close to 0 as the penetration point would be forced through the paste. With this method, it has been found that values higher than 12 Shore are necessary to obtain a satisfactory result, at least for the geometries tested.

By a method according to the invention, the step of shaping a green body by forcing the pastes through a die preferably thereby directly provides the green body with a shape corresponding to the desired final shape of the composite component as obtained after the step of sintering or oxidizing. By “corresponding to” is meant that the dimensions typically change a bit due to the chemical reactions taking place during the sintering or oxidizing. For some geometries, this may also give rise to minor changes in shape. But the overall final shape is caused by the pastes being forced through the die so that the green body thereby obtains a shape matching the shape of the die. This will be illustrated in the figures. Such a shaping method differs from e.g. 3D-printing, where the shape of the component is obtained by moving the die, also referred to as a nozzle, and/or a working platform holding the component being manufactured relative to each other and building the component layer by layer.

The difference in electric resistivity between the regions of the sintered or oxidized component made of the different pastes is typically a factor of between 2 and 20. However, other factors are also covered by the scope of protection. The values used will be determined in accordance with the desired non-constant electrical properties needed for a given application of the component.

In relation to the present invention and the description thereof, the focus will be on the varying electric resistivity along the composite component as that is the parameter that is used to determine the compositions of the pastes. However, since the varying electric resistivity is due to different compositions of the different pastes, other parameters typically vary as well. These parameters could e.g. be mechanical properties, such as stiffness and fracture strength. Examples of possible design parameters used to obtain the different compositions are given below. In case the initial studies for a given application show that compositions of the pastes determined to obtain a desired varying electric resistivity give rise to unsatisfactory mechanical properties of the composite component, it may be necessary to make a compromise with respect to the compositions as long as all design requirements are still fulfilled.

As mentioned above, the varying electric resistivity along a longitudinal direction of the component results from the first composition being different from the second composition. This will typically be due to the first and second compositions having different electric resistivities, which could be referred to as “initial electric resistivities”, which result in what could be referred to as “final electric resistivities” after sintering or oxidizing. The initial electric resistivities are typically several orders of magnitude higher on the green bodies compared to the electric resistivities of the sintered or oxidized component.

The first aspect of the invention as described above could alternatively be worded as a method of manufacturing a composite component, the method comprising the following steps:
preparing a plurality of pastes comprising:
   at least a first paste having a first composition with a first electric resistivity when sintered or oxidized, and
   at least a second paste having a second composition with a second electric resistivity when sintered or oxidized,
transferring the plurality of pastes into a supply chamber of a processing equipment, to shape a green body with a longitudinal change in type of paste when forced from the supply chamber through a die of the processing equipment, and
sintering or oxidizing the shaped green body to obtain the composite component having a varying electric resistivity along a longitudinal direction of the component, the longitudinal direction corresponding to the direction of movement of the pastes through the die, and the varying electric resistivity resulting from the first electric resistivity being different from the second electric resistivity after sintering or oxidizing.

Throughout the description, the wording “sintering or oxidizing” is used, but this is not meant to exclude that both sintering and oxidation takes place.

In presently preferred embodiments of the invention, there are more than two different pastes, and they may all have different compositions.

In some embodiments of the invention,
the first paste comprises metal powder with a first alloy composition, ceramic powder, and a first binder,
the second paste comprises metal powder with a second alloy composition and a second binder, and

wherein the first alloy composition and the second alloy composition both consist of at least one chemical element, and wherein the chemical elements are chosen so that, for each of the chemical elements being present in an amount higher than 0.5 weight % in each of the alloy compositions, that chemical element is comprised both in the first and second alloy composition, and
for the chemical elements being present in the first alloy composition in amounts of up to 5.0 weight %, the amount of that chemical element differs by at most 1 percentage point between the first and second alloy compositions, and
   for the chemical elements being present in the first alloy composition in amounts of more than 5.0 weight %, the amount of that chemical element differs by at most 3 percentage point between the first and second alloy compositions.

Hereby it can be obtained that after sintering or oxidizing, the metal powder form a coherent structure without any abrupt interfaces between materials originating from two neighbouring pastes. Thereby weaknesses, such as due to defects, that could otherwise lead to fracture can be avoided. Further advantages of having the first and second compositions as just described are that the metal structure has substantially the same properties throughout the component; such properties are e.g. the mechanical properties, corrosion resistance and creep resistance. Furthermore, the metal part of the composite component will have substantially the same heat expansion and shrinkage both during the sintering or oxidizing and during use of the component whereby the risk of thermal stresses can be minimized.

The wording “alloy” is used throughout the description and claims, since most often the first and second alloy compositions each comprises at least two chemical elements forming an alloy. For embodiments including using at least one paste with only one chemical element, this is also included in the wording “alloy” even though it could also simply be referred to as “metal composition” instead of “alloy composition”. This means that the different compositions of the two or more different pastes may include one or more of the pastes having only one chemical element, such as iron or copper.

A binder or a binding agent is any material or substance that holds or draws other materials together to form a cohesive unit mechanically, chemically, by adhesion or cohesion. The binder is preferably organic, such as cellulose ethers, agarose or polyoxymethylene. Examples of binders are: methylcellulose, 25 poly(ethylene oxide), poly(vinyl alcohol), sodium carboxymethylcellulose (cellulose gum), alginates, ethyl cellulose and pitch.

The first binder and the second binder may have similar or the same solvability in order to ensure the same flow properties of the extruded material during the extrusion.

In some embodiments of the invention, a paste typically comprises binder in an amount of 2 to 8 weight % of the paste, such as in an amount of 2 to 6 weight % of the paste, or such as in an amount of 3 to 5 weight % of the paste. A paste typically further comprises liquid, such as water, in an amount of 5 to 25 weight % of the paste, such as in an amount of 5 to 15 weight % of the paste, such as 5 to 10 weight % of the paste, or it may be in an amount of 10 to 20 weight % of the paste, such as in an amount of 12 to 18 weight % of the paste.

In embodiments as described above, the second paste may further comprise a ceramic powder. The metal powder and the ceramic powder may in any of the embodiments have the same average particle size which may result in an easier and more uniform mixing. In alternative embodiments, they have different particle sizes. By using different particles sizes, a better packing of the powders may be obtained so that it is easier to avoid pores in the sintered or oxidized composite component.

In embodiments comprising ceramic powder, the different electric resistivities may be obtained by varying one or more of the following parameters:
the volume ratio between the metal powder and the ceramic powder,
the size of the ceramic particles,
the shape of the ceramic particles, and
the type of the ceramic material.

By “size” is meant any measure typically used to describe this parameter in relation to powder. It typically includes taking into account both the average size and the size distribution of the particles.

The different electric resistivities are obtained, because ceramic materials have electric resistivities which are several orders of magnitude higher than those of metal materials. The metal materials used for the present invention typically have an electrical resistivity in the range from 10⁻⁵ to 10⁻⁸ Ω·m at 20° C., and the ceramic materials typically have an electric resistivity above 10 Ω·m at 20° C., e.g. in the range from 10⁹ to 10²⁵ Ω·m at 20° C. Which of the design parameters to use may depend on the requirements on other properties of the composite component, such as mechanical stiffness or impact strength. The determination of the actual choice for a given component can be made e.g. by experimentation and/or by computer simulations.

In addition to the parameters mentioned above, the final resistivities could also be influenced by varying process parameters, such as the sintering temperature, the duration of the sintering, and the sintering atmosphere. Which parameters to choose for a given material combination could e.g. be determined by experimentation and/or computer simulations.

In embodiments of the invention wherein the component comprises both metal powder and ceramic powder, and wherein the final component is obtained by sintering of the green body, the sintering is typically performed at temperatures high enough to sinter together the metal but not the ceramic. Which sintering temperature to use depends on the material compositions, but the sintering temperature will typically be 1000-1450° C. The amount of metal powder should preferably be so that a coherent metal structure is obtained.

The metal powder may be in the form of spherical or substantially spherical particles. Spherical powder facilitate a high powder loading which makes it possible to use less binder and reduce shrinkage both in debinding and sintering. Spherical powder also has better flow characteristics when processing, such as extruding. The ceramic powder may also be in the form of spherical particles.

In any of the embodiments of the invention comprising metal powder, each of the metal powders of the first paste and of the second paste may comprise one or more of the following chemical elements: iron, copper, chromium, aluminium, cobalt, nickel, manganese, molybdenum, vanadium, yttrium, and silicon.

In any of the embodiments comprising ceramic powder, the ceramic powder may comprise one or more of the following: Alumina, Zirconia, Boron Nitride, Cordierite, and Silicon Nitride.

The step of preparing a plurality of pastes may comprise supplying material from at least two feeding chambers into a mixing chamber in varying amounts, and preparing the plurality of pastes in the mixing chamber. Each of the supplies of the material may be pre-mixed, e.g. in an extruder. An example of such an embodiment will be described in relation to the figures. The varying amounts are typically obtained by varying the speed of worms in the feeding chambers.

The processing equipment used in any of the embodiments as described above may e.g. be an extruder or a tape casting machine.

A predetermined order in which the plurality of pastes are transferred into the supply chamber may correspond to the longitudinal direction of the component being manufactured. The order of the different pastes can be chosen so that one region of the composite component has a higher or lower electric resistivity compared to other parts in the component according to desired design for a given application. In the figures, an example will be shown to illustrate an embodiment in which the resistivity is highest in the middle region of the composite component compared to the end regions, whereas the resistivity at one end region of the composite component is higher than the resistivity at the other end region of the composite component.

The plurality of pastes may be transferred to the supply chamber before the step of shaping is initiated. This may e.g. be relevant in a piston extruder and for the manufacturing of components being no longer than what corresponds to the volume of the supply chamber of the extruder. Hereby it may be easier to control that the pastes are arranged as intended, before the extrusion is performed.

Alternatively, the step of shaping may be initiated before all of the plurality of pastes have been transferred to the supply chamber. This may e.g. be relevant for long components where there is not enough space for all the pastes in the supply chamber at the same time.

The step of shaping a green body may be performed by continuously forcing the pastes through the die. Alternatively, it may be possible to temporarily pause the shaping, e.g. in order to add more pastes to the supply chamber.

In some embodiments of the invention, the die has a pattern of outlets resulting in the green body having at least one longitudinally extending internal channel. The die may e.g. have a pattern of outlets resulting in the green body having a plurality of longitudinally extending internal channels arranged in a regular pattern, such as having a honeycomb structure. An example of such a component will be shown in the figures. The scope of protection covers the manufacturing of a component of any shape which can be made by forcing pastes through a die. The outer geometry of the component may e.g. be a simple geometry, such as a rod or a plate, or it may be a more complex geometry.

In any of the embodiments as described above, a step of debinding may precede the step of sintering or oxidizing, the debinding step preferably comprising heating the green body to a temperature at which at least some, such as all, of the binder burns off. Debinding is the process in which the binder is removed from the green body to ensure that no leftover carbon is present in the component during sintering. This debinding is typically done by heating the green body to a temperature between 200 to 750 degrees Celsius and allowing the binder to burn off. Different binders require different debinding temperatures. In embodiments using methylcellulose, the debinding is done in an oxidizing atmosphere, typically air, but it can also be done partially in the same atmosphere as the sintering atmosphere, if the final component is not ruined by the extra content of carbon. In order to ensure that the debound green body can still be handled, it may be necessary to oxidize the powder slightly together; these oxides will be removed in the sintering process.

A second aspect of the invention relates to a composite component having an electric resistivity which varies along a longitudinal direction of the composite component, wherein the composite component has been manufactured by a method according to the first aspect of the invention, so that the longitudinal direction corresponds to a direction of movement of the pastes through a shaping die during manufacturing of the composite component.

In some embodiments of the invention, such a composite component has been manufactured from pastes comprising metal powder and ceramic powder.

As described above in relation to the first aspect of the invention, the varying electric resistivity may be due to variations in one or more of the following parameters:
the volume ratio between the metal powder and the ceramic powder,
the size of the ceramic particles,
the shape of the ceramic particles, and
the type of the ceramic material.

The electric resistivity may be substantially constant in cross-sections perpendicular to the longitudinal direction of the composite component. This can e.g. be obtained by ensuring that the pastes have the same or substantially the same flow properties, such as the same viscosity, so that mixing of material from two subsequently arranged pastes during shaping is limited. The viscosity of a given paste can be determined by equipment and methods designed therefore, such as by use of those methods described above.

The composite component may have at least one longitudinally extending internal channel. The composite component may have a plurality of longitudinally extending internal channels, such as have a honeycomb structure.

The first and second aspects of the present invention may each be combined. These and other aspects of the invention will be apparent from and elucidated with reference to the embodiments described hereinafter.

### BRIEF DESCRIPTION OF THE FIGURES

The method of manufacturing a composite component according to the invention will now be described in more detail with regard to the accompanying figures. The figures show one way of implementing the present invention and is not to be construed as being limiting to other possible embodiments falling within the scope of the attached claim set.

FIG. 1 shows schematically the overall idea of having a composite component with varying electric resistivity along a length direction of the composite component.

FIG. 2 shows schematically how two pastes are extruded into a composite component having regions with different electric resistivities.

FIG. 3 shows schematically cross-sections of a composite component, the two cross-sections comprising different amounts of ceramic particles.

FIG. 4 shows a graph of how the electric resistivity varies as a function of the amount of the ceramic alumina.

FIGS. 5.a and 5.b shows schematically two examples of shapes of components that can be manufactured with a method according to the present invention.

FIG. 5.c shows schematically an example of a die that can be used for manufacturing of a component with an array of longitudinally extending inner channels.

FIG. 6 shows schematically a processing equipment that can be used in a method according to the present invention.

FIG. 7 shows a flow diagram of a method according to the invention.

### DETAILED DESCRIPTION OF AN EMBODIMENT

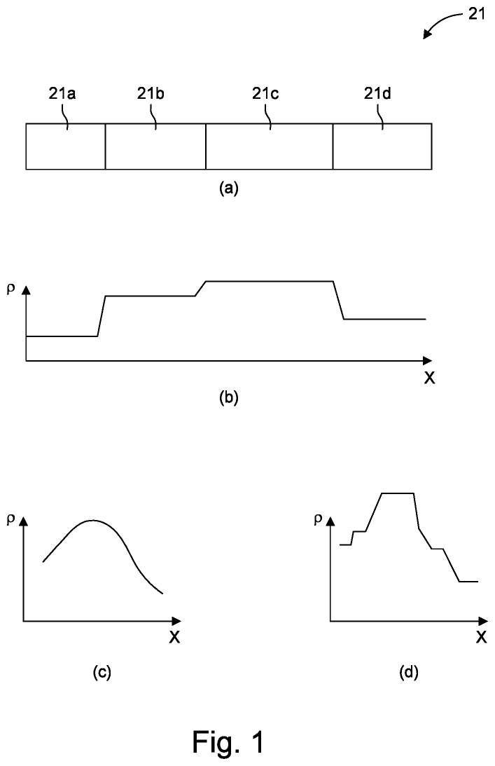

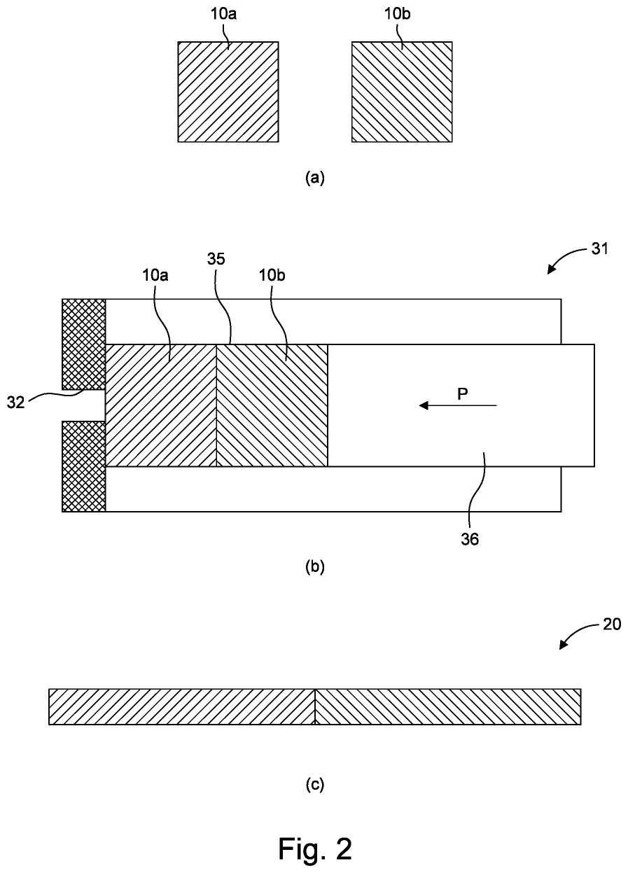

The present invention is in a first aspect related to the manufacturing of a composite component 21 having an electric resistivity which varies along a longitudinal direction of the composite component 21. FIG. 1.a shows schematically an example of such a composite component 21 which has four regions 21a, 21b, 21c, 21d with different electric resistivities along the longitudinal direction corresponding to a direction of movement of the pastes through a shaping die 32 (see FIG. 2) during manufacturing of the component 21. FIG. 1.b shows a curve of the electric resistivity ρ as a function of position along the length X of the component 21 in FIG. 1.a. In this illustrated embodiment, the electric resistivity varies in steps and with a constant increase rate in the narrow regions around the borders between the different regions 21a, 21b, 21c, 21d. However, the scope of protection also covers a non-constant increase rate. FIG. 1.c shows schematically an example of what could be an ideal curve for a given application where a smooth change in electric resistivity ρ would be desired. FIG. 1.d shows an example of an actual curve for a component to be used in the application having the ideal curve as in FIG. 1.c.

FIG. 2 shows schematically the overall steps in the method. FIG. 2.a shows the step of preparing a first paste 10a having a first composition, and a second paste 10b having a second composition. The step of preparing the pastes may be performed by kneading the materials in a kneader, such as a Z-blade kneader or sigma blade kneader. Such a type of mixer has a high torque and a specific geometry of the mixing blades which has been found suitable for obtaining a homogenous mixture of the type of paste as described above, which paste typically has a high viscosity. The first and second pastes 10a, 10b are then transferred into a supply chamber 35 of a processing equipment 31, which in FIG. 2.b is schematically shown as a piston extruder. The pastes 10a, 10b are forced from the supply chamber 35 through a die 32 of the processing equipment 31 to result in a green specimen 20 as shown in FIG. 2.c. By moving the piston 36 towards the die 32, typically at a constant speed, the green body 20 is formed by continuously forcing the pastes 10a, 10b through the die 32. As shown for this embodiment, the order in which the pastes 10a, 10b are transferred into the supply chamber 35 corresponds to the longitudinal direction of the component 21 being manufactured. In presently preferred embodiments, the step of shaping is performed by an extruder, and the extrusion is performed at room temperature and with the pastes having a temperature of at most 50 degrees Celsius, such as at most 40 degrees Celsius, preferably at most 30 degrees Celsius. Hereby the properties of the pastes may be easier to control over time, since no significant amount of water or other liquid present in the pastes will evaporate at these temperatures, and the binder will not reach its gelation temperature.

After this shaping, and possibly a further step of drying, the green body is sintered or oxidized to obtain the composite component 21 having a varying electric resistivity along a longitudinal direction of the composite component 21. The sintering may e.g. be done in a reducing atmosphere, in vacuum, or in an inert atmosphere. The sintering is typically performed in a furnace at temperatures of 950 to 1430 degrees C. As explained in more details above, a step of debinding may precede the step of sintering or oxidizing, the debinding step typically comprising heating the green body to a temperature at which at least some, such as all, of the binder burns off.

As seen from FIG. 2, the longitudinal direction of the green body 20 and thereby the composite component 21 corresponds to the direction of movement of the pastes 10a, 10b through the die 32, and the varying electric resistivity ρ results from the first composition being different from the second composition. As illustrated in FIG. 2, the green body 20 obtains a shape matching the shape of the die 32. Apart from possible minor changes caused by the following processing steps, this shape also corresponds to the shape of the final composite component 21.

In preferred embodiments of the invention, the first paste 10a comprises metal powder with a first alloy composition, ceramic powder, and a first binder. The second paste 10b comprises metal powder with a second alloy composition and a second binder. The first alloy composition and the second alloy composition both consist of a plurality of chemical elements. Each of the metal powders of the first paste 10a and of the second paste 10b may comprise one or more of the following chemical elements: iron, copper, chromium, aluminium, cobalt, nickel, manganese, molybdenum, vanadium, yttrium, and silicon. Examples of alloys that have been used in the development work leading to the present invention are FeCrAl, TWIP, 316L, and 17-4PH. However, the invention can be used for many other alloys.

The second paste 10b typically also comprises a ceramic powder. The ceramic powder used for the first and second compositions typically comprises one or more of the following: Alumina, Zirconia, Boron Nitride, Cordierite, and Silicon Nitride.

The different electric resistivities ρ in the pastes 10a,10b are typically obtained by varying one or more of the following parameters:
the volume ratio between the metal powder and the ceramic powder,
the size of the ceramic particles,
the shape of the ceramic particles, and
the type of the ceramic material.

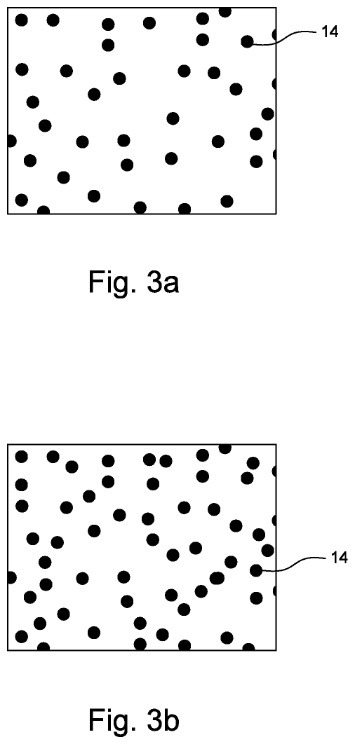

FIG. 3 schematically shows two examples of cross-sections of components having different volume fractions of ceramic 14. In FIG. 3 the ceramic particles are shown as black even though they are white in the real components. Due to the significant differences in electric resistivity between metal and ceramic materials, the different examples of volume fractions shown in FIG. 3 result in different electric resistivities. The characteristics of the material in relation to the ceramic particles, such as the parameters mentioned above as well as the distribution, can e.g. be analysed by microscopy of polished cross-sections of the components.

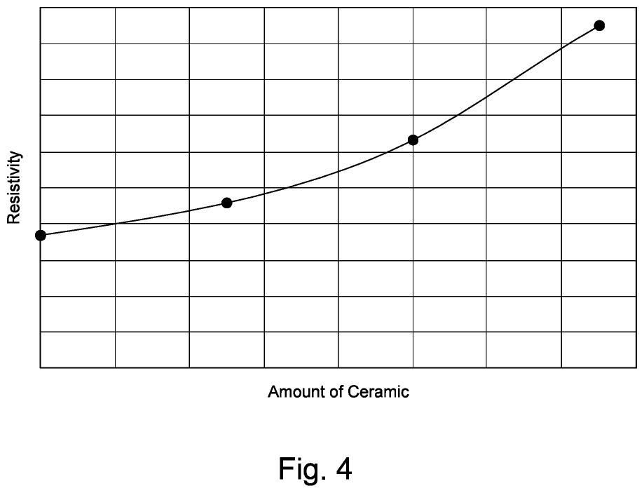

FIG. 4 shows results obtained during the development of the present invention. It shows how the electric resistivity ρ of a composite component varies as a function of the content of ceramic in the form of Alumina. The graph is based on experiments where the electric resistivity along a composite component made with a method as described above was measured. The electric resistivity was measured by applying a known current to the component and measuring the voltage drop with two probes arranged in contact with the component with a fixed distance between them. The experiments were made both at room temperature and at a higher temperature, and both showed varying electric resistivity. For some of the materials used for the development of the present invention, the electric resistivity is almost constant over the relevant temperature ranges. The composite component may e.g. be used in a heating system wherein electrical power is used to heat an electrically conducting component due to the electric resistivity of the metal and then the heated metal is used for the heating of another media, such as a fluid flowing along the metal. In such an application, an electric resistivity that is almost independent of the temperature makes the heating process stable and controllable, and it may be easier to avoid hotspots. An example of materials with almost constant electric resistivity is FeCrAl alloys which are used in a wide range of resistance and high-temperature applications. They have a resistivity of about 1.4 μΩ·m and a temperature coefficient of +49 ppm/K (i.e. +49×10⁻⁶ K⁻¹).

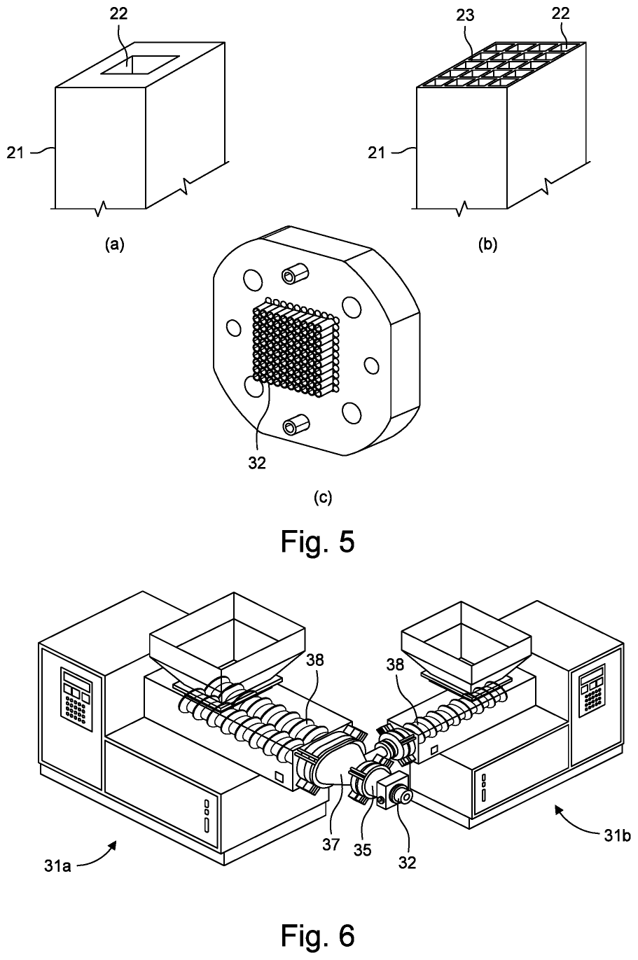

FIGS. 5.a and 5.b shows schematically two examples of the overall shapes of composite components 21 that can be produced with a method according to the present invention. FIG. 5.a shows a component 21 having one longitudinally extending internal channel 22. FIG. 5.b shows a component having a plurality of longitudinally extending internal channels arranged in a regular pattern and separated by walls 23. These geometries are obtained by using dies 32 having shapes and arrangements corresponding to the cross-sectional shapes of the components. FIG. 5.c shows an example of a possible design of a die 32 that can be used for the manufacturing of a component 21 having an array of longitudinally extending internal channels.

FIG. 6 shows schematically an example of a processing equipment having two extruders 21a, 21b each supplying material into one mixing chamber 37, in the form of a manifold, possibly in varying amounts, so that the plurality of pastes for the final extrusion into a green body 20 are prepared in the mixing chamber 37. By “prepared” is preferably meant that they are mixed into a homogeneous material. The mixing chamber may include a mixer to perform at least part of the kneading. From the mixing chamber 37, a continuous flow of pastes is transferred to the supply chamber 35 from where it is forced through a die 32 in order to form the green body 20. The supply chamber 35 can be a separate chamber, but it can also be the part of the mixing chamber 37 adjacent to the die 32. The processing equipment shown in FIG. 6 has one single-worm extruder 31b and one twin-worm extruder 31a, but it could also be two of the same type. By varying the speeds of the worms 38, it is possible to control the compositions of the pastes being prepared from material supplied from the two extruders. It would e.g. be possible to supply a material comprising ceramic powder with one extruder and material without ceramic with the other extruder. Then the amount of ceramic in the paste being prepared depends on the relationships between the speeds of the two extruders.

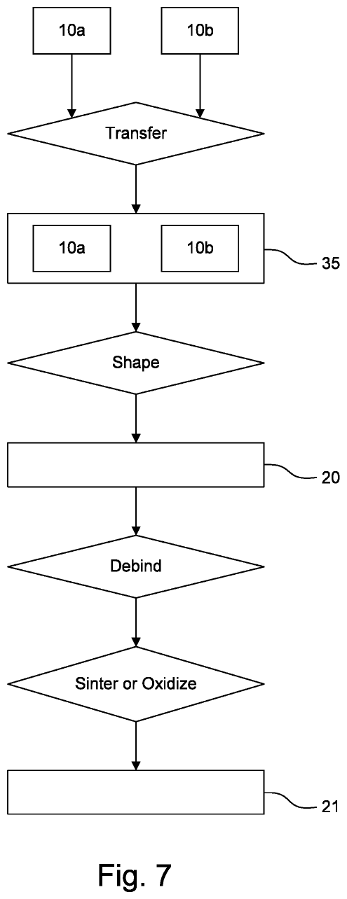

FIG. 7 shows a flow diagram of an embodiment of a method according to the invention. First a plurality of pastes 10a, 10b are prepared as described above. FIG. 7 shows two pastes, but there could be more. This preparation could be performed by kneading the materials in a kneader, such as a Z-blade kneader or sigma blade kneader. The pastes 10a,10b are then transferred into a supply chamber 35 of a processing equipment 31. In the corresponding step in FIG. 6, this transfer into the supply chamber 35 will cause some mixing so that there is not a sharp border between the pastes. The processing equipment 31 is used to shape a green body 20 from the plurality of pastes 10a,10b by forcing the pastes 10a,10b from the supply chamber 35 through a die 32 of the processing equipment 31 as also shown in FIG. 2. In the embodiment in FIG. 7, a step of debinding the green body is then performed; this step may be preceded by a not shown step of drying. Such a debinding step is optional and whether or not to include it will e.g. depend on the materials used. The debinding step typically comprises heating the green body 20 to a temperature at which at least some of the binder burns off. Different binders require different debinding temperatures, and typical debinding temperatures are between 200 to 750 degrees Celsius. Finally, the green body 20 is sintered or oxidized to obtain the composite component 21 having the varying electric resistivity ρ along the longitudinal direction of the composite component 21. A drying step is typically performed in a controlled atmosphere involving controlling the temperature and the humidity in which the green body is placed. It may further include passing a flow of gas, such as air, along the green body, and the speed of the flow of the gas may then also be controlled.

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. Furthermore, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. Method of manufacturing a composite component having a varying electric resistivity (ρ) along a longitudinal direction, the method comprising the following steps:
preparing a plurality of pastes comprising:
at least a first paste having a first composition, and
at least a second paste having a second composition,
transferring the plurality of pastes into a supply chamber of a processing equipment,
shaping a green body from the plurality of pastes by forcing the pastes from the supply chamber through a die of the processing equipment, and
sintering or oxidizing the green body to obtain the composite component having the varying electric resistivity (ρ) along the longitudinal direction of the composite component, the longitudinal direction corresponding to the direction of movement of the pastes through the die, and the varying electric resistivity (ρ) resulting from the first composition being different from the second composition.

2. Method according to claim 1, wherein:
the first paste comprises metal powder with a first alloy composition, ceramic powder, and a first binder,
the second paste comprises metal powder with a second alloy composition and a second binder, and
wherein the first alloy composition and the second alloy composition both consist of at least one chemical element, and wherein the chemical elements are chosen so that, for each of the chemical elements being present in an amount higher than 0.5 weight % in each of the alloy compositions, that chemical element is comprised both in the first and second alloy composition, and
for the chemical elements being present in the first alloy composition in amounts of up to 5.0 weight %, the amount of that chemical element differs by at most 1 percentage point between the first and second alloy compositions, and
for the chemical elements being present in the first alloy composition in amounts of more than 5.0 weight %, the amount of that chemical element differs by at most 3 percentage point between the first and second alloy compositions.

3. Method according to claim 2, wherein the first binder and the second binder have similar or the same solvability.

4. Method according to claim 2, wherein the second paste further comprises a ceramic powder.

5. Method according to claim 1, wherein the different electric resistivities (ρ) are obtained by varying one or more of the following parameters:
the volume ratio between the metal powder and the ceramic powder,
the size of the ceramic particles,
the shape of the ceramic particles, and
the type of the ceramic material.

6. Method according to claim 2, wherein each of the metal powders of the first paste and of the second paste comprises one or more of the following chemical elements: iron, copper, chromium, aluminium, cobalt, nickel, manganese, molybdenum, vanadium, yttrium, and silicon.

7. Method according to claim 1, wherein the step of preparing a plurality of pastes comprises supplying material from at least two feeding chambers into a mixing chamber in varying amounts, and preparing the plurality of pastes in the mixing chamber.

8. Method according to claim 1, wherein a predetermined order in which the plurality of pastes are transferred into the supply chamber corresponds to the longitudinal direction of the composite component being manufactured.

9. Method according to claim 1, wherein the step of shaping a green body is performed by continuously forcing the pastes through the die.

10. Method according to claim 1, wherein the die has a pattern of outlets resulting in the green body having at least one longitudinally extending internal channel.

11. Method according to claim 10, wherein the die has a pattern of outlets resulting in the green body having a plurality of longitudinally extending internal channels arranged in a regular pattern, such as having a honeycomb structure.

12. Method according to claim 2, wherein a step of debinding precedes the step of sintering or oxidizing, the debinding step preferably comprising heating the green body to a temperature at which at least some, such as all, of the binder burns off.

13. Composite component having an electric resistivity (ρ) which varies along a longitudinal direction of the composite component, wherein the composite component has been manufactured by a method according to claim 1, so that the longitudinal direction corresponds to a direction of movement of the pastes through a shaping die during manufacturing of the composite component.

14. Composite component according to claim 13, wherein the composite component has been manufactured from pastes comprising metal powder and ceramic powder.

15. Composite component according to claim 14, wherein the varying electric resistivity (ρ) is due to variations in one or more of the following parameters:
the volume ratio between the metal powder and the ceramic powder,
the size of the ceramic particles,
the shape of the ceramic particles, and
the type of the ceramic material.

16. Composite component according to claim 13, wherein the electric resistivity (ρ) is substantially constant in cross-sections perpendicular to the longitudinal direction of the composite component.

17. Composite component according to claim 13, wherein the composite component has at least one longitudinally extending internal channel, such as wherein the composite component has a plurality of longitudinally extending internal channels, such as has a honeycomb structure.
